(19) United States
(12) Patent Application Publication
(10) Pub. No.: US 2004/0228314 A1
(43) Pub. Date: Nov. 18, 2004

(54) Device for joint detection of cdma codes for multipath downlink

(76) Inventors: Laurent Ros, Meylan (FR); Genevieve Jourdain, Tencin (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/484,208

(22) PCT Filed: Aug. 7, 2002
(86) PCT No.: PCT/FR02/02386

(30) Foreign Application Priority Data
Jul. 30, 2001 (FR) 01/10293

(51) Int. Cl. H04B 7/216; H04J 3/00

(52) U.S. Cl. 370/342; 370/345; 455/63.1

(57) ABSTRACT

A conjoint detection device for UMTS/TDD mobile radio telephone terminal receiver processes a received signal having symbols coded in accordance with K CDMA codes and having passed through a propagation channel with Lₜ multiple paths. The device has two channels each imposing Lₜ/2 respective delays and each having K filtering branches. Each filtering branch correlates Lₜ/2 delayed sample sequences to a respective code and to Lₜ/2 estimated path coefficients in order to sum Lₜ/2 coefficients correlated in this way sampled at the symbol period. 2K equalization filters then equalize linearly the 2K correlated signals, depending on an associated code, before they are summed at the output of the two channels. Thanks to the division into two channels, there are sufficient degrees of freedom to cancel the interference out exactly for a finite depth of the 2K equalization filters greater than twice the duration of the propagation channel.

The present invention relates to code division multiple access (CDMA) digital transmission in a cellular radio telephone system.

The invention relates more particularly to a multiple access digital symbol detection device for use in the receiver of a Time-Division Duplex (TDD) mode Universal Mobile Telecommunication System (UMTS) mobile radio telephone terminal to combat intersymbol interference on the downlink from a base station to the mobile terminal.

Before commenting on devices for conjoint detection of CDMA codes for use on a UMTS downlink, a few features of TDD mode UMTS transmission are briefly described.

A Time-Division Multiple Access (TDMA) frame on a physical propagation channel has a duration of 10 ms and comprises 15 timeslots. Up to K=16 simultaneous bursts of data are transmitted simultaneously in each timeslot, usually assigned to K respective users, although two or more bursts can be assigned to the same user. The CDMA code cₖ for one burst and a given user, designated by the integer index k where 1≦k≦K, is defined by a channelization code sequence of Q code elements, known as chips, associated with oversampling of each symbol of period Tₛ. The number Q of chips is called the spreading factor and is equal to 16. In CDMA mode, the number K of active codes is less than or equal to Q. A timeslot may contain 2 560 chips of period T_{c}=Tₛ/Q.

In practice, each timeslot is divided into two data fields of identical length bracketing a median training sequence, known as a midamble, consisting of 256 or 512 chips for estimating the propagation channel. The symbols are estimated sequentially by filtering with a global detector depth, or predetermined memory depth as it is also known, of P_{d} symbols. Thus a data symbol in a timeslot is estimated as a function of the result of the linear processing of a portion of samples corresponding to a duration P_{d}.Tₛ that is less than the duration of a timeslot.

Furthermore, on transmission in the base station, each chip can be oversampled with an oversampling factor S at least equal to 2. Thus for a data symbol, QS samples with a sampling period Tₛ/SQ corresponding to Q chips are emitted after four-states phase modulation.

Also, although in practice the receiver of the mobile terminal can have more than one antenna, it is assumed hereinafter that the block diagrams of the known detection devices and detection devices according to the invention, including those shown in the drawings, relate to only one antenna.

In a cellular radio telephone system cell, unlike the uplink, the downlink is synchronous, because the signals to the various user terminals in the cell are synchronized on transmission by the base station. In the case of an ordinary base station, the signals from the various users are always synchronized at the input of the receiver of the mobile terminal after traveling the same propagation channel. In the environment of the mobile radio terminal concerned, propagation is effected via a plurality of propagation paths, typically Lₜ=2 to 6 dominant paths.

The purpose of conjoint detection of K CDMA codes c₁ to c_{K} in the mobile terminal of a given user is to estimate the symbols carrying the code assigned temporarily to the given user, which is assumed to be the code number kᵤ, using the known K−1 codes of the other users, that interfere with each other. A conjoint detection device generally cancels out some of the interference, including multiple access interference between codes and interference between symbols. In the presence of additive noise at the input of the receiver of the terminal, it is beneficial not to cancel the interference out completely, in accordance with a forcing to zero criterion, but instead to minimize the overall effect of the noise and the interference with a minimum mean square error (MMSE) criterion. Nevertheless, if the additive noise is negligible compared to the useful signal, it is desirable for the residual interference to be very low. For a given conjoint detection device structure, it is then the theoretical ability of that structure to cancel the interference out exactly in the absence of additive noise that is of interest. This property is often not achieved by practical known structures.

In the conjoint detection prior art, two conjoint detection device structures known as a T_{c}-structure and a Tₛ-structure operate symbol by symbol.

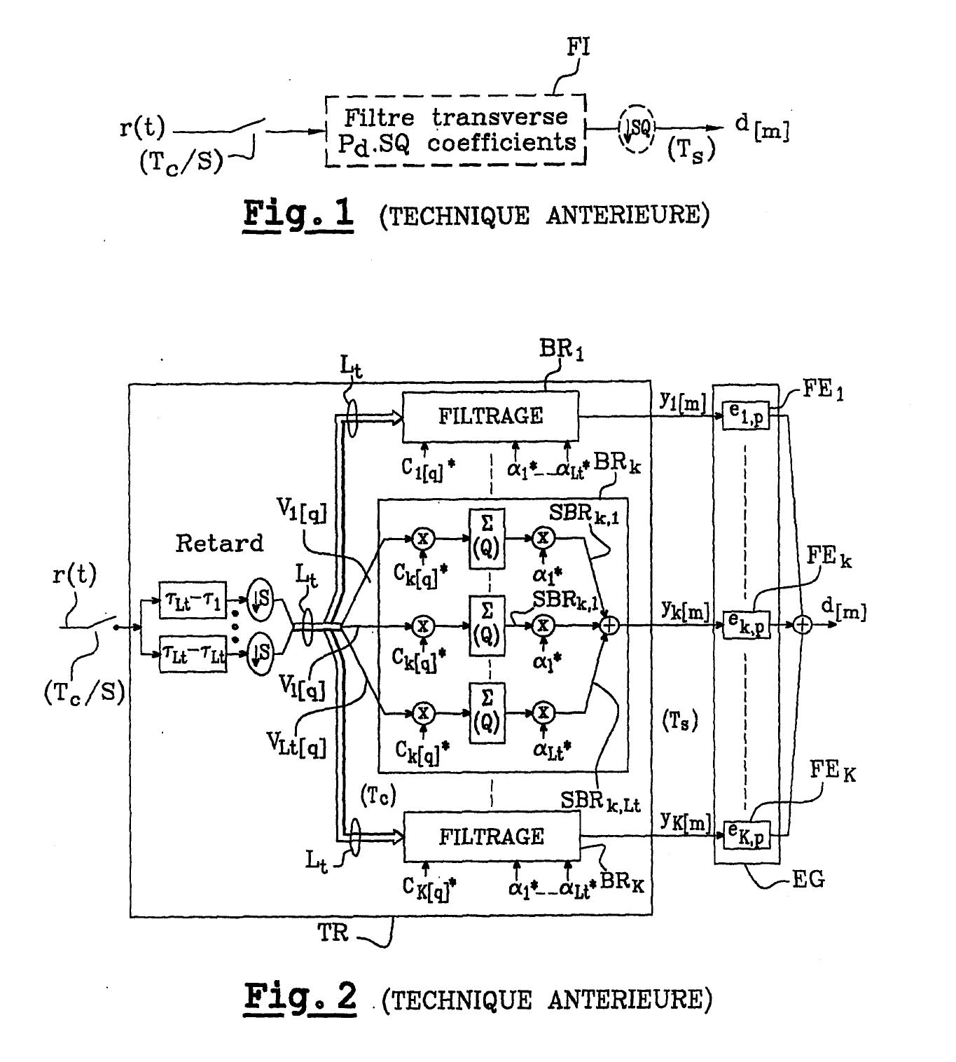

The T_{c}-structure shown in FIG. 1 comprises a fractionated transversal filter FI operating, at the input, at a timing rate T_{c}/S on the received baseband signal r(t) previously filtered in the analog domain, where S is the oversampling factor, typically equal to 1, 2 or 4, and, at the output, at the timing rate Tₛ of the symbol estimates. In a multipath context, the T_{c}-structure is disclosed in French patent application FR-A-2793363 in particular and is referred to as a “row equalizer”. Once the coefficients of the transversal filter FI have been calculated from parameters of the channel, each symbol is estimated sequentially by a scalar product of the corresponding received sample portion and a set of SQP_{d} coefficients of the filter.

The T_{c}-structure can be regarded as <<free>> since, for a chosen sampling increment Tₛ/SQ at the input, it effects linear, non-recursive processing, without imposing any specific structure, unlike the Tₛ-structure. An essential feature of this detection device is that it is capable of canceling the interference out exactly for a particular length:

$${P}_{d} \geq \frac{K Ws}{( SQ - K )}$$

where Wₛ designates the integer number of symbols necessary to cover the length of the impulse response of the propagation channel between the base station and the terminal, hereinafter called the channel duration, expressed in symbol periods. In fact it can be verified that exact cancellation necessitates solving a system of K(Wₛ+P_{d}) linear equations with SQP_{d} “unknowns” that are the coefficients of the filter FI and which can therefore be chosen correctly in the least squares sense, for example, since the system admits of solutions, i.e. is underdetermined.

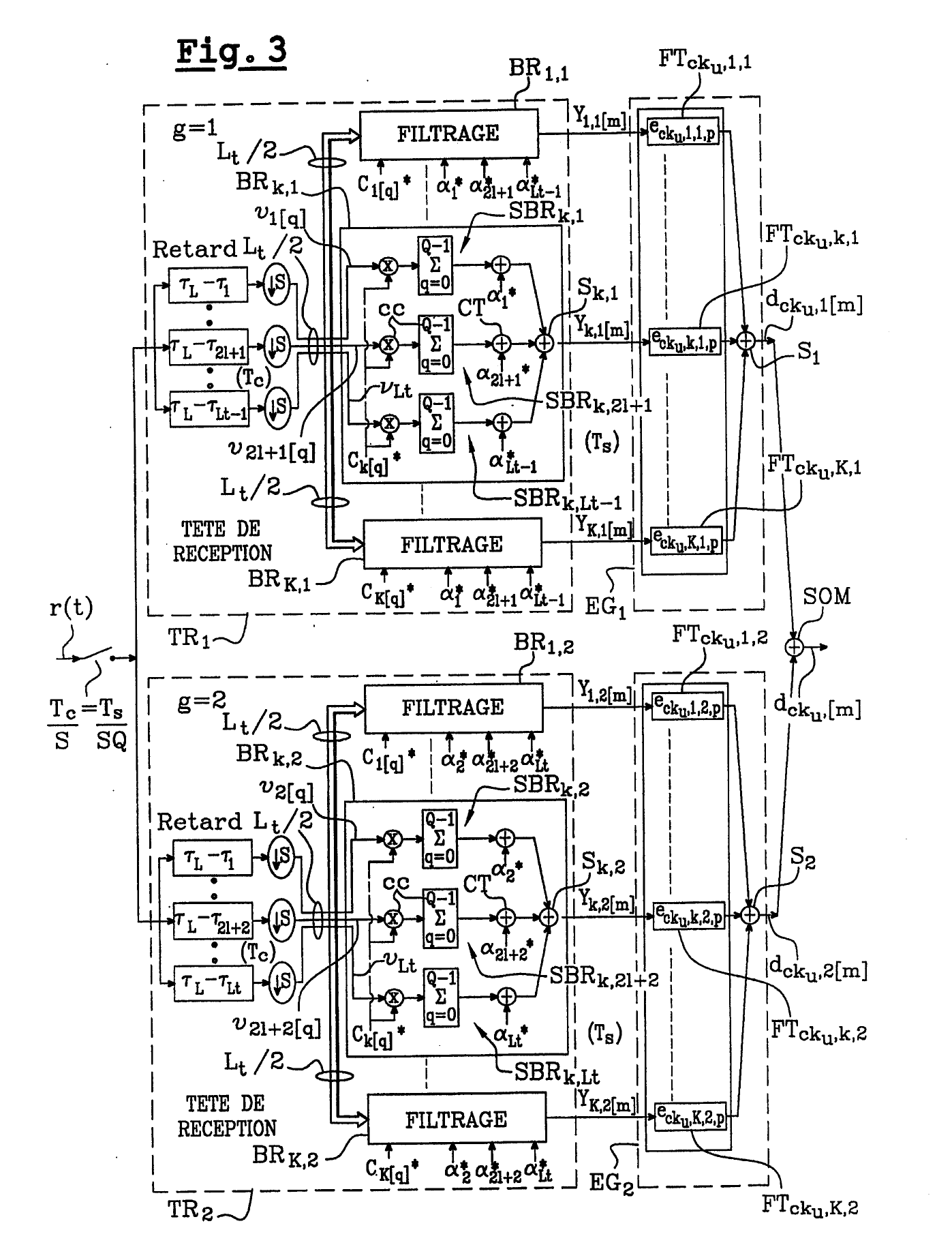

The Tₛ-structure shown in FIG. 2 comprises two portions, namely a wideband receive head TR receiving the received signal r(t) diversely retarded by the multiple paths and a symbol time Tₛ equalizer EG, both of which are derived from the linear theoretical structure disclosed in the book “MULTIUSER DETECTION” by Sergio VERDU, Cambridge University Press, 1998, pages 243-246.

The receive head TR contains K parallel filtering branches BR₁ to BR_{K} associated with the respective codes c_{1[q]} to c_{K[q]} and delivering discrete signals Y_{1 [m]} to Y_{K[m]} at the symbol time mTₛ to the K inputs of the equalizer. Each branch BRₖ includes a filter matched to the code c_{k[q]} and to the propagation channel and a synchronous symbol time Tₛ=Q.T_{c} undersampler. In practice, with a multipath channel, the discrete signal y_{k[q]} produced by the branch BRₖ shown in detail in FIG. 2 is the result of summing symbol time outputs of Lₜ sub-branches SBR_{k,1} to SBR_{k,Lt} associated with Lₜ respective propagation paths. The sub-branch SBR_{k,l} of the branch BRₖ, where 1≦l≦Lₜ, correlates the received signal r(t) delayed by τ_{Lt}−τₗ at correlates the code c_{k[q]}. The output of the sub-branch SBR_{k,l} is weighted by the estimated complex signal αl* of the path “l”. Thus the matched filtering branch BRₖ recombines the paths by directly combining the results of the correlations respectively associated with the multiple paths.

In a single-user context (K=1), the particular receive head structure TR is called a “rake” to suggest the rake shape of the filter matched to the channel formed of discrete paths. The depths of the receive head TR is Wₛ+1 symbols, i.e. Wₛ symbols for the filter matched to the propagation channel and one symbol for the filter matched to the respective code in each of the parallel branches. The K symbol time samples Y_{1[m]} to Y_{K[m]} reconstituted by the receive head TR are applied to K respective transversal filters FE₁ to FEₖ in the equalizer EG. Each symbol time transversal filter FEₖ (with 1=k=K) has P coefficients e_{k,1}, . . . e_{k,p}, . . . e_{k,P} and operates at symbol time. The global depth in symbols of the detection device is therefore P_{d}=P+Wₛ.

The T_{c}-structure has essentially three drawbacks compared to the Tₛ-structure.

The first drawback stems from the fact that the T_{c}-structure effects all the processing on the samples that are at the fastest timing rate T_{c}/S instead of effecting some of the processing at the symbol period Tₛ on samples obtained after correlation with the codes. Thus the T_{c}-structure does not exploit the discrete path nature of the propagation channel or the correlation properties of the CDMA signals and has a very large number of coefficients P_{d} SQ≦Wₛ.SQ if the impulse response of the transversal filter FI is required to cover the duration of the channel, which is desirable in the presence of noise. It is less complex, compared to the receive head TR of the Tₛ-structure, because of the much lower number of multiplications per second, depending on the number of paths Lₜ and not on the channel duration Wₛ, in other words, in total, one complex multiplication per path and per code in each symbol period Tₛ.

The second drawback relates to the calculation of coefficients, which is much more complex than in the Tₛ-structure because it necessitates a description of the system at the code sub-element time T_{c}/S instead of at the symbol time Tₛ. Determining the coefficients depends on forming and pseudo-inverting a correlation matrix of large dimension [(P_{d} SQ)×(P_{d} SQ)], instead of a [KP×KP] matrix.

The third drawback relates to multi-code transmission, whereby plural of the K active codes are associated with the same mobile radio telephone terminal. The T_{c}-structure must be duplicated as many times as there are associated codes to be decoded, whereas in the Tₛ-structure the receive head TR is retained and only symbol time processing must be multiplied at the rate of one equalizer per associated code.

The advance in terms of complexity of the Tₛ-structure over the T_{c}-structure is described above. The main strength of the Tₛ-structure is primarily a result of the fact that that the bank of complete matched filters in the branches BR₁ to BR_{K} has completely compacted the information. In fact, the samples Y_{1[m] to Y}_{K[m]} produced at symbol time Tₛ constitute an exhaustive summary of the samples received for estimating the symbols emitted.

However, the Tₛ-structure has a major drawback. For complete cancellation of interference, it theoretically necessitates filtering branches with infinite memory, necessitating processing of all the samples received to decide on one symbol at symbol time Tₛ. In fact, there is no exact solution of finite duration, guaranteeing cancellation of interference, for the estimation of coefficients based on an overdetermined system of K(2W_{S}+P) linear equations with only KP unknown parameters, which are the coefficients. For a given code, the number 2W_{S}+P results from global transfer, from the emitter to the receiver, up to the estimation variable d_{[m]}, by way of send formatting, the propagation channel, the matched receive filtering and the equalizer of depth P.

In practice, the interference becomes negligible for a depth P of the equalizer EG two or three times greater than the channel duration Wₛ and the Tₛ-structure remains attractive. Nevertheless, in theory nothing is guaranteed and it is not possible to forecast the necessary depth, which depends on the characteristics of the channel and the number of active codes.

The object of the invention is to provide a conjoint detection device structure depending on known or estimated propagation path parameters that retains the two features of practical benefit that were mutually exclusive in the T_{c} structure and the Tₛ structure of the prior art.

Accordingly a conjoint detection device for a received signal supporting symbols each conjointly coded by K codes and sampled at one chip period at most, and having passed through a propagation channel with Lₜ multiple paths, comprising Lₜ delay means for delaying samples of the received signal with estimated delays caused by the paths, K filtering means for correlating delayed received sample sequences each to a respective code and to estimated path coefficients, and equalization means for samples at the symbol period delivered by the filtering means, is characterized in that it has two parallel channels each grouping Lₜ/2 respective delay means, K filtering means for correlating Lₜ/2 sample sequences delayed by the Lₜ/2 respective delay means each to a respective code and to a respective one of Lₜ/2 estimated path coefficients in order to sum Lₜ/2 signals correlated in this way and delivered at the symbol period, and K equalization means for linearly equalizing the respective K correlated signals depending on an associated code, and in that it comprises means for summing 2K equalized signals at the symbol period delivered conjointly by the 2K equalization means in the two channels.

Thanks to the above features, the detection device of the invention offers advantages of the two prior art structures previously cited, namely:

exact cancellation of the interference, if any, for a finite depth P of the symbol time equalization means such that P=2W_{S}; however, the number K(2W_{S}+P) of linear equations to be solved that depend on the duration of the channel Wₛ and the number K of codes and the depth P of the equalization means can be such that P<2W_{S} depending on the possible choice of the coefficients of each equalization means, which confers an interference cancellation solution that is inexact but less complex than that of the T_{c}-structure; in contrast to the Tₛ-structure, the filter means retain sufficient degrees of freedom for exact cancellation of interference to be possible with symbol time equalization means of finite duration; and

processing in two steps, one based on correlations with active codes and multiple paths, executed in the filter means, the other on symbol time equalization, executed in the equalization means with transversal filters, which was acquired with the Tₛ-structure; if well conducted, these two steps guarantee reasonable complexity.

Moreover, the correlation with the codes in CDMA mode constitutes a natural and satisfactory first step because it enables the attributes of the received signal to be brought out before any subsequent processing.

In the structure of the conjoint detection device according to the invention, the filter matched to the channel (recombining the various paths) is not implemented conventionally in the wideband receive head, as in the Tₛ-structure, but is accomplished only indirectly via the two sets each of K equalization means.

Other features and advantages of the present invention will become more clearly apparent on reading the following description of several preferred embodiments of the invention given with reference to the corresponding appended drawings, in which:

FIG. 1 is a functional block diagram of a prior art T_{c}-structure conjoint detection device already commented on;

FIG. 2 is a functional block diagram of a prior art Tₛ-structure conjoint detection device already commented on; and

FIG. 3 is a functional block diagram of a conjoint detection device according to the invention.

According preferred embodiment, shown in FIG. 3, a device in accordance with the invention for conjoint detection of CMDA codes is included in the receiver of a UMTS mobile telephone terminal and offers a structure with two parallel channels each essentially comprising a wideband receive head TR₁, TR₂ consisting of K parallel branches and a symbol time Tₛ equalizer EG₁, EG₂ consisting of K parallel discrete transversal filters each with P coefficients. Each channel TR₁-EG₁, TR₂−EG₂ receives a signal r(t) at the timing rate T_{c}/S=Tₛ/SQ and delays it relative to only a respective half of all the multiple paths.

The received signal r(t) sampled at the timing rate Tₛ/SQ is made up of baseband complex binary elements corresponding to the four phase states {l, j, −l, −j} or {l+j, −l+j, −l−j, l−j} depending on the standard I and Q channels of the quadrature phase shift keying (QPSK) modulation to which the signal emitted by the base station has been subjected. By default, all signals and operations considered hereinafter are complex, and decisions as to the complex symbols filtered and equalized by the device of the invention are effected subsequently.

It is assumed that in the conjoint detection device according to the invention the task of estimating the propagation channel between the emitter in a base station and the receiver has been carried out beforehand, i.e. that the parameters such as time delays, amplitudes and phases of the signals caused by the multiple paths have been identified beforehand. Channel estimation can be carried out beforehand in the standard way using training sequences (midambles) inserted in the middle of the timeslots.

To ensure a good balance in terms of average amplitude and average delay between the even number of paths Lₜ shared between the two channels, the Lₜ estimated delays τ₁ to τ_{Lt} caused by the multipaths, expressed as an integer number of code sub-elements at the timing rate Tₛ/SQ, are arranged in increasing order and distributed chronologically in the two channels, with one path in two on each channel:

the first channel TR₁-EG₁ contains Lₜ/2 parallel delay lines imposing respective estimated delays of τ_{L}−τ₁, . . . τ_{L}−τ₂ₗ₊₁, . . . τ_{L}−τ_{Lt-1} where 0≦l≦(Lₜ/2)−1 and τ_{L} expresses, as a number of code sub-elements, the maximum delay (last path), rounded to the next higher symbol:

τ_{L}=Wₛ.S.Q≧τ_{Lt},

and supplying a group “g”=1 of delayed received sample sequences with odd suffixes ν_{1[q]}, . . . ν_{2l+1[q]}, . . . ν_{Lt-1[q];}

the second channel TR₂-EG₂ contains Lₜ/2 parallel delay lines imposing respective estimated delays of τ_{L}−τ₂, . . . τ_{L}−τ₂l₊₂, . . . τ_{L}−τ_{Lt} where 0≦l≦(Lₜ/2)−1, and supplying a group “g”=2 of delayed received sample sequences with even suffixes ν_{2[q]}, . . . ν_{2l+2[q]}, . . . ν_{Lt[q].}

The wideband receive heads TR₁ and TR₂ and the equalizers EG₁ and EG₂ have respective structures that are identical, and for this reason only one channel TR_{g}-EG_{g} is described hereinafter, and the description applies regardless of the value 1 or 2 of the suffix g.

The delayed received sample sequences {ν_{2l g+g[q]}} at the input of the receive head TR_{g} are applied to Lₜ/2 respective undersamplers with an undersampling rate S in order for the delayed received samples to be changed to the chip timing rate T_{c}. The delayed received sample sequences at the timing rate T_{c} are applied conjointly to first inputs of Lₜ/2 correlators in each of K parallel matched filtering branches BR_{1,g} to BR_{K,g} that are respectively associated with the codes c_{1[q]} à c_{K[q]} and deliver respective discrete signals Y_{1,g[m]} à Y_{K,g[m]} to K inputs of the respective equalizer EG_{g} at each symbol period Tₛ indexed by the integer suffix “m” to mark the times “mTₛ”.

Thus the receive head TR₁-TR₂ does not recombine the Lₜ paths into a single group, but instead recombines the Lₜ paths into two groups each of K branches, at the rate of two branches per active code c_{k[q].}

The basic branch BR_{k,g} depicted in FIG. 3 includes, in cascade in each of Lₜ/2 sub-branches SBR_{k,2l+g}, firstly, a correlator CC for correlating a respective one {ν_{2l+g[q]}} of the Lₜ/2 delayed received sample sequences applied at the timing rate T_{c} with the respective code c_{k[q]} with Q chips and delivering at the output synchronous samples at the symbol time Tₛ=T_{c}/Q, and, secondly, a multiplier CT for applying relative weighting to the respective path with suffix “2 l+g” of the propagation channel by weighting the outputs of the correlator CC by the complex coefficient α₂ₗ_{_{+g}}* of the path “2 l+g” defined by an estimated amplitude and an estimated phase.

Alternatively, the order of the operations is reversed: for the branches BR_{k,1} and BR_{k,2} which are then adjoining, the received signal r(t) sampled at T_{c}/S is first subjected to filtering matched to the respective code c_{k[q]} delivering samples at the timing rate T_{c}/S, before undergoing two recombinations of different paths on two separate channels g=1 and g=2, each by weighting and delay relative to the respective Lₜ/2 paths.

The discrete signal Y_{k,g[m]} is produced by an adder S_{k,g} at the output of the branch BR_{k,g} summing the symbol time outputs of the Lₜ/2 sub-branches SBR_{k,g} to SBR_{k,2(L}_{t/2-1)+g} associated with each of the Lₜ/2 respective propagation paths of the group “g”, and therefore resulting from the double summation of scalar products as follows for each sample:

$${Y}_{k , g [ m ]} = {\sum }_{l = 0}^{\frac{{L}_{t}}{2} - 1} ( {\sum }_{q = 0}^{Q - 1} {c}_{{k [ q ]}^{*}} \cdot {v}_{2} {l}_{+ g [ m Q + q ]} ) \cdot {α}_{2} {l}_{+ {g}^{*}}$$

where (.)* designates a conjugate complex, and {c_{k[q]}, 0≦q≦Q−1} designates the Q chips of code number “k” transmitted at the timing rate T_{c} which are complex bits in the set of four phase states {l, j, −l, −j} or {l+j, −l+j, −l−j, l−j} of the QPSK phase modulation.

Given the shape of the code, the correlation with the code represented by the sum in parentheses in the preceding equation for Y_{k,g[m]} uses only additions and subtractions.

Splitting the filtering matched to the multipath channel into two channels TR₁ and TR₂ compared to the Tₛ Tₛ-structure retains sufficient degrees of freedom to cancel out exactly the interference in the equalizers EG₁ and EG₂ together having 2 KP coefficients if the depth P is sufficient, that is if P=2W_{S}, where Wₛ is the duration of the propagation channel expressed in symbol periods.

The K samples Y_{1,g[m]} à Y_{K,g[m]} at the symbol time reconstituted by the receive head TR_{g}, corresponding primarily to grouping correlation peaks with the highest path amplitudes, are applied to K respective discrete transversal filters FT_{ck}_{ᵤ}_{,1,g} to FT_{ck}_{ᵤ}_{,K,g} in the respective equalizer EG₉ in channel g. The K transversal filters FT_{ck}_{ᵤ}_{,1,g} to FT_{ck}_{ᵤ}_{,K,g} equalize the symbols emitted that have been coded only with the respective sequence code cₖ_{ᵤ}_{[q]} assigned to the radio telephone terminal of user kᵤ, with 1≦kᵤ≦K. Each transversal filter FT_{ck}_{ᵤ}_{,k,g} has P=P1+1+P2 coefficients e_{ck}_{ᵤ}_{,k,g,-P1} to e_{ck}_{ᵤ}_{,k,g,P2} and operates at the symbol time Tₛ. An adder S_{g} at the output of the equalizer EG_{g} and therefore of the channel g sums the results from the K filters FT_{ck}_{ᵤ}_{,1,g to FT}_{ck}_{ᵤ}_{,K,g} into the next sample:

$${d}_{{ck}_{u} , g [ m ]} = {\sum }_{k = 1}^{k = K} {\sum }_{p = - {P}_{1}}^{p = + {P}_{2}} {e}_{c {k}_{u} , k , q , p} {Y}_{k , g [ m - p ]}$$

where P=P₁₊₁+P₂ is the number of coefficients of the equalizer EG_{g} and P₁ is its estimation delay in symbols.

The depth P of the equalizer EG_{g} is therefore P=P_{d}−Wₛ symbols, where P_{d} again designates the global depth of the detection device, expressed in symbols.

The samples d_{ck}_{ᵤ}_{,1[m]} and d_{ck}_{ᵤ}_{,2 [m]} produced by the adders S₁ and S₂ at the outputs of the equalizers EG₁ and EG₂ are summed to produce a decision variable d_{ck}_{ᵤ}_{[m]} in an adder SOM at the output of the detection device. The symbol time equalizer EG₁-EG₂ forms the decision variable d_{ck}_{ᵤ}_{[m]} to decide on symbols emitted relating to the code number kᵤ of the respective sequence cₖ_{ᵤ}_{[q]} assigned to the terminal. The decision is taken subsequently, symbol by symbol, by comparison with the four stored complex values of the set previously cited {l, j, −l, −j} or {l+j, −l+j, −l−j, l−j}, in a decision circuit connected to the output of the adder SOM, in order to deduce the value of the corresponding complex symbol emitted at the timing rate mT_{S}, before a “phase demodulation” supplying the corresponding two bits.

Thus according to the invention, exact cancellation of the interference in the equalizers EG₁ and EG₂ necessitates solving a system of K(2W_{S}+P) equations with the 2 KP coefficients of the transversal filters in the whole of the two equalizers, instead of KP coefficients for the T_{S}-structure.

The principle of determining the coefficients from the known channel and the known codes, here with a dimension of 2 KP, is explained hereinafter.

The vector of size 2 KP containing all the coefficients for estimating the symbols relating to the code cₖᵤ is obtained, with a mean minimum square error criterion MMSE, from the following matrix equation:

(e_{ck}_{ᵤ})^{T}=(l_{Δ})^{T}·τ(γd)^{H}[τ(γd)·τ(γd)^{H}+σ₀²·τₜₙ(β)]⁻¹

in which (.)^{T} and (.)^{H} respectively represent the transposition and transconjugation operators and σ₀²=N₀/2E_{b} is the variance of additive Gaussian noise having a monolateral spectral density N₀ and E_{b} is the average energy transmitted per useful bit after demodulation of a complex symbol into two bits. Knowing the variance σ₀² implies knowing the noise to signal ratio at the input of the receiver. In practice, the variance σ₀² has a regulating role and can be set at a value from 0.1 (−10 dB) to 0.01 (−20 dB).

The matrix τ(γd) has a size of 2 KP rows×K(P+2W_{S}) columns and represents the transfer at the symbol time between P+2W_{S} symbols for each of K user terminals and the 2K outputs of the “multiuser” branches of the receive head TR₁-TR₂.

The matrix τtn(β) is a 2 KP×2 KP matrix that contains the temporal correlation to a depth of P symbols in each equalizer EG₁, EG₂ and from one branch to the other at the output of the receive head TR₁-TR₂.

The transposed vector (l_{Δ})^{T}=[0, . . . 0, 1, 0, . . . 0] selects the Δth row from the K(P+2W_{S}) rows, where Δ=K(P₁+²Wₛ+kᵤ) is set on the basis of the chosen delay P₁ of the equalizer EG₁, EG₂.

With a zero-forcing criterion canceling the interference completely if P≧2W_{S} and without taking account of the noise, the leftward pseudo-inverse of the transfer matrix τ(γ_{d}) is formed, namely:

(e_{cku})^{T}=(l_{Δ})^{T}[τ(γ_{d})^{H}·τ(γ_{d})]⁻¹·τ(γ_{d})^{H}.

For this criterion, there is no need to know the level of noise and to form the matrix τₜₙ(β).

If P<2W_{S}, the coefficients are obtained with the same formula for the MMSE criterion. For the zero-forcing criterion, a non-cancelled residual interference power appears; the coefficients are obtained by substituting zero for σ₀² in the formula for the MMSE criterion.

Alternatively, the detection device is adaptive at the level of the phases of the signals of path α_{2l+g}* in the correlators CT and at the level of the coefficients e_{ck}_{ᵤ}^{,k,g,p} in the transversal filters of the equalizers EG₁ and EG₂.

Instead of being estimated directly using the equations previously cited, the phases of the Lₜ channel path signals and/or the 2 KP coefficients of the equalization filters can be determined conjointly and iteratively, depending on a median training sequence (midamble) of 256 or 512 chips included in the bursts of the signal received in TDD/UMTS mode, and/or updated as a function of an error signal for the error between the decision variable d_{ck}_{ᵤ}_{[m]} at the output of the detection device and the symbol decided on by the decision circuit connected to the output of the adder SOM.

If the characteristics of the propagation channel do not vary much, which corresponds to a virtually immobile mobile telephone terminal, the symbols in the two fields of the useful symbol of a burst are updated as a function of the training sequence contained in the burst. If the characteristics of the propagation channel vary rapidly, which corresponds to a terminal in a moving vehicle, the useful symbols are updated by the error signal previously cited, symbol by symbol.

1-4. (canceled)

5. A conjoint detection device for a received signal supporting symbols each conjointly coded by K codes and sampled at one chip period at most, said received signal being arranged to have passed through a propagation channel with Lₜ multiple paths, said device comprising:
two parallel channels each arranged for grouping:
Lₜ/2 respective parallel delay means for delaying samples of said received signal with respective estimated delays caused by said paths into Lₜ/2 delayed sample sequences,
K filtering means respectively associated with said K codes, each filtering means being arranged for correlating said Lₜ/2 delayed sample sequences to the respective code and to Lₜ/2 estimated path coefficients into Lₜ/2 correlated signals arranged to be delivered at said symbol period and summing said Lₜ/2 correlated signals into one of K correlated signals, and
K equalization means respectively for linearly equalizing said K correlated signals depending on one of said K codes assigned to said device into K equalized signals, and
means for summing all said K equalized signals at said symbol period arranged to be delivered conjointly by all said K equalization means in said two parallel channels.

6. A device according to claim 5, wherein each of said K equalization means comprises a discrete transversal filter having a number of coefficients greater than twice the duration of said propagation channel expressed in symbol period.

7. A device according to claim 5, wherein the Lₜ delay means is arranged for imposing Lₜ respective estimated delays caused by said Lₜ multiple paths and are arranged in increasing order and distributed chronologically in said two parallel channels, with one path in two on each of said parallel channels.

8. A device according to claim 5, wherein the coefficients are arranged to be determined iteratively in said equalization means and to be dependent on a training sequence included in bursts of said received signal.

9. A device according to claim 5, wherein phases of signals on said Lₜ multiple paths in said filtering means are arranged to be determined iteratively in said filtering means and dependent on a training sequence included in bursts of said received signal.

10. A conjoint detection device for a received signal supporting symbols each conjointly coded by K codes and sampled at one chip period at most, said received signal being arranged to have passed through a propagation channel with Lₜ multiple paths, said device comprising:
two parallel channels each arranged for grouping:
Lₜ/2 respective parallel delays for delaying samples of said received signal with respective estimated delays caused by said paths into Lₜ/2 delayed sample sequences,
K filters respectively associated with said K codes, each filter being arranged for correlating said Lₜ/2 delayed sample sequences to the respective code and to Lₜ/2 estimated path coefficients into Lₜ/2 correlated signals, the K filters being arranged to deliver the Lₜ/2 correlated signals at said symbol period and sum said Lₜ/2 correlated signals into one of K correlated signals,
K equalizers respectively for linearly equalizing said K correlated signals depending on one of said K codes assigned to said device into K equalized signals, and
a summer for summing all said K equalized signals at said symbol period arranged to be delivered conjointly by all said K equalizers in said two parallel channels.

11. A device according to claim 10, wherein each of said K equalizers comprises a discrete transversal filter having a number of coefficients greater than twice the duration of said propagation channel expressed in symbol period.

12. A device according to claim 10, wherein the Lₜ delays are arranged for imposing Lₜ respective estimated delays caused by said Lₜ multiple paths and are arranged in increasing order and distributed chronologically in said two parallel channels, with one path in two on each of said parallel channels.

13. A device according to claim 10, wherein said equalizers are arranged to determine the coefficients iteratively and to cause the coefficients to be dependent on a training sequence included in bursts of said received signal.

14. A device according to claim 10, wherein said filters are arranged to determine phases of signals on said Lₜ multiple paths iteratively and to cause the phases of the signals on said Lₜ multiple paths to be dependent on a training sequence included in bursts of said received signal.

15. A conjoint detection method responsive to a received signal supporting symbols each conjointly coded by K codes and sampled at one chip period at most, said received signal having passed through a propagation channel with Lₜ multiple paths, said method comprising:
supplying the received signal to two parallel channels, each channel performing the following steps:
delaying samples of said received signal with respective estimated delays caused by said paths into Lₜ/2 delayed sample sequences;
correlating said Lₜ/2 delayed sample sequences to the respective code and to Lₜ/2 estimated path coefficients into Lₜ/2 correlated signals delivered at said symbol period and summing said Lₜ/2 correlated signals into one of K correlated signals;
linearly equalizing said K correlated signals depending on one of said K codes into K equalized signals; and
conjointly summing all said K equalized signals at said symbol period.

16. The method according to claim 15, wherein the coefficients are determined iteratively during the equalization step and to be dependent on a training sequence included in bursts of said received signal.

17. The method according to claim 15, wherein phases of signals on said Lₜ multiple paths are determined iteratively and depending on a training sequence included in bursts of said received signal.
